(19) United States
(12) Patent Application Publication
(10) Pub. No.: US 2001/0034629 A1
(43) Pub. Date: Oct. 25, 2001

(54) Process for facilitating the conception of inventions in a directed manner

(76) Inventor: John E. Cronin, Milton, VT (US)

Correspondence Address: Ryan K. Simmons, ipCapital Group, Inc., Suite 325, 400 Cornerstone Dr., Williston, VT, 05495, US

(21) Appl. No.: 09/781,365

(22) Filed: Feb. 12, 2001

Related U.S. Application Data
(60) Provisional application No. 60/181,459, filed on Feb. 10, 2000.
(60) Provisional application No. 60/179,675, filed on Feb. 2, 2000.
(60) Provisional application No. 60/181,816, filed on Feb. 11, 2000.
(60) Provisional application No. 60/181,825, filed on Feb. 11, 2000.

(51) Int. Cl. G06F 17/60

(52) U.S. Cl. 705/7; 705/1

(57) ABSTRACT

In general, in one aspect, the invention features a method of facilitating the conception of one or more inventions in a target market and/or technology areas by a group of one or more participants. The method may include the following; a set of one or more steps accomplished by a facilitator, and may include one or more of the following steps. First, communicating guidelines for creative thinking to the participants, wherein the guidelines for creative thinking may include creativity tools. Second, facilitating any one or more of the following steps: conceiving of and establishing a mess statement; conceiving of facts, data, and/or relevant attributes relevant to the mess statement; conceiving of problem statements related to the mess statement, wherein the problem statements may be identified using creativity tools and/or creative stimuli comprising one or more of the facts, data, and/or relevant attributes as creative stimuli; conceiving of elements of solutions to the problem statements, wherein the elements may be conceived using creative stimuli such as the problem statements and one or more of the facts, data, and attributes as creative stimuli; conceiving of inventions using one or more creative stimuli which may include stimuli selected from one or more creativity tools using one or more of the problem statements and one or more elements; and expanding one or more of the inventions.

### CROSS REFERENCE TO RELATED CO-PENDING APPLICATIONS

This application claims the benefit of, and expressly incorporates herein by reference, the entire disclosures of the following U.S. Patent Applications:

U.S. patent application Ser. No. ______ (ipCG-507), entitled SYSTEM AND METHOD FOR FACILITATING THE CONCEPTION OF INVENTIONS IN A DIRECTED MANNER, filed Feb. 12, 2001, which in turn claims priority to U.S. patent application Ser. No. 60/181,459, entitled PROCESS FOR FACILITATING THE CONCEPTION OF INVENTIONS IN A DIRECTED MANNER, filed Feb. 10, 2000;

U.S. patent application Ser. No. ______ (ipCG-508), entitled NETWORK BASED SYSTEM AND METHOD FOR FACILITATING THE CONCEPTION OF INVENTIONS IN A DIRECTED MANNER, filed Feb. 12, 2001, which in turn claims priority to U.S. patent application Ser. No. 60/181,816, entitled WEB-BASED PROCESS FOR FACILITATING THE CONCEPTION OF INVENTIONS IN A DIRECTED MANNER, filed Feb. 11, 2000;

U.S. patent application Ser. No. ______ (ipCG-509), entitled INVENTION INTERVIEW PROCESS, filed Feb. 12, 2001, which in turn claims priority to U.S. patent application Ser. No. 60/181,741, entitled INVENTION INTERVIEW PROCESS, filed Feb. 11, 2000;

U.S. patent application Ser. No. ______ (ipCG-519), entitled AUTOMATED IP TRACKING SYSTEM AND METHOD, filed Feb. 12, 2001, which in turn claims priority to U.S. patent application Ser. No. 60/181,741, entitled AUTOMATED IP PROCESS FOR TRACKING IP MATTERS, filed Feb. 11, 2000;

U.S. patent application Ser. No. ______ (ipCG-506), entitled SCANNING INVENTION PROCESS, filed on Jan. 19, 2001, which in turn claims priority to U.S. patent application Ser. No. 60/179,675, entitled SCANNING INVENTION PROCESS, filed Jan. 19, 2001.

### FIELD OF THE INVENTION

The invention provides a novel method for directly facilitating conception by one or more persons of one or more potentially patentable inventions in a targeted area, such as a specific technology field or market space.

### BACKGROUND OF THE INVENTION

Art relating to the background of the invention is discussed in the ensuing subsections.

### Invention as a Creative Process

The degree of human inventiveness distinguishes humans from all other animals. The earliest human archeological sites are characterized by the presence of tools invented by humans. The advent of recorded history is the direct result of human invention, and that history is largely a history of human invention, as seen in the advance of science and technology and corresponding changes in human social, organizational and political structures. Today, the inventive process is the source of an unprecedented pace of technological development, which characterizes the ever-changing modern world.

Given the historical and cultural importance of invention, many researchers have investigated the mental processes associated with inventing. For example, Colangelo et al. investigated mechanical inventiveness (i.e., the conception and development of new devices which require use of mechanical principles) to identify psychological characteristics shared by successful inventors (Ciba Identified. Symp. 1993, 178:160-70). Other researchers have focused on the creative aspects of groups. Still others have investigated the effects of social or organizational structures on inventiveness. Lamoreaux et al., for example, investigated the effects of economic changes on the rate of invention and concluded that high rates of inventive activity encourage the evolution of a market for technology, which in turn encourages greater specialization and inventive productivity at invention as individuals find it increasingly feasible to sell and license their discoveries (Proc Natl Acad Sci U.S.A. 1996;93(23):12686-92).

### Invention Process as a Legal Property Process

Most countries of the world have established legal schemes to govern the patenting of inventions. Patent laws are typically administered by a centralized patent office, and only licensed patent attorneys and/or agents are legally permitted to represent others before such office.

In the United States, the patent system is based on Article I of the U.S. Constitution and consists of an enormous body of statutory law, case law, regulations and procedures, and is administered by the U.S. Patent and Trademark Office (USPTO). Although individual inventors may represent themselves before the USPTO, only registered patent attorneys and patent agents may represent others. Patent attorneys and agents must qualify for registration by passing a federally administered exam. The exam requires prospective patent attorneys and agents to demonstrate a detailed knowledge of patent law and procedure. However, while patent attorneys and agents are experts in patent law, they typically have no formal training in the art of inventing or in techniques for working with inventors or others to facilitate invention.

### Methods for Developing Inventions

Inventions are commonly perceived to be the result of highly creative cognitive processes achievable by only a few unusually talented individuals. Furthermore, it is commonly believed that only those with extensive training in certain highly technical fields have the necessary background for inventing. At an organizational level, these misconceptions can result in inefficient use of intellectual resources.

Numerous methods are known for enhancing or stimulating creativity. Examples include brainstorming, the Theory of Inventive Problem Solving method (TRIZ), and creative problem solving. Of these methods, only TRIZ specifically relates to facilitating invention of potentially patentable ideas. Developed in Russia, TRIZ (the acronym is based on the Cyrillic spelling) focuses on the methodological resolution of contradictions through the application of innovative solutions.

None of the presently used methods for facilitating creativity even attempts to employ a predefined set of rules to facilitate conception by one or more persons of one or more completely new inventions within targeted technology fields or market spaces.

There is a need in the art for a method of facilitating invention, which permits an organization to fully benefit from the inventive capacity of its personnel resources, including its employees, outside contractors, and others associated with the organization. The method should result in the generation of multiple inventions and should facilitate the conception of inventions in targeted areas, such as targeted market areas or targeted technology areas. Moreover, the method should facilitate assessment of the inventions by the organization in a manner which helps to ensure (1) that the organization's financial resources are wisely invested in the most promising of the inventions thus conceived; and (2) that cost-effective business decisions can be made regarding which inventions should be selected for the costly investment required for patent prosecution.

### SUMMARY OF THE INVENTION

The invention relates to a method of facilitating the conception of one or more inventions in target market and/or technology areas by a group of one or more participants. First, the method may include communicating guidelines for creative thinking to the participants, wherein the guidelines for creative thinking may include creativity tools. Second, the method may include facilitating any one or more of the following steps: conceiving of and establishing a mess statement; conceiving of facts, data, and/or attributes relevant to the mess statement; conceiving problem statements related to the mess statement, wherein the problem statements may be identified using creativity tools and/or creative stimuli comprising one or more of the facts, data, and/or relevant attributes as creative stimuli; conceiving elements of solutions to the problem statements, wherein the elements may be conceived using creative stimuli such as the problem statements and one or more of the facts, data, and attributes as creative stimuli; and conceiving inventions using one or more creative stimuli which may include stimuli selected from one or more creativity tools using one or more of the problem statements and one or more elements. Finally, the method may include expanding one or more of the inventions.

The method may further include a set of one or more steps accomplished by the participant(s), e.g. conceiving and establishing a mess statement; conceiving facts, data, and/or relevant attributes relevant to the mess statement; conceiving problem statements related to the mess statement, wherein the problem statements may be identified using creative stimuli comprising one or more of the facts, data, and/or relevant attributes as creative stimuli; conceiving elements of solutions to the problem statements, wherein the elements may be conceived using creative stimuli such as the problem statements and one or more of the facts, data, and attributes as creative stimuli; conceiving inventions using one or more creative stimuli, which may include stimuli selected from one or more creativity tools using one or more of the problem statements and one or more elements; and expanding one or more of the inventions.

The steps involved in the method of facilitating the conception of one or more inventions in a target market and/or technology areas by a group of one or more participants may be accomplished by the participants and facilitated by the facilitator. The facilitator may also acts as a participant.

The inventions may be assessed based on pre-determined criteria to identify a list of most valuable inventions. The information about the inventions, which may include a ranking of the invention according to one or more business or technical criteria, may be communicated to a decision-making group.

Prior to communicating guidelines for creative thinking, the facilitator communicates basic concepts of patentability to the first group of participants. The basic concepts of patentability may include one or more of the following: novelty; utility; nonobviousness; inventive step; ladder abstraction; bar dates; publication as a means of obtaining freedom of action and as a low cost way to protect basic inventions by patenting the basic inventions and publishing the incremental improvements around the basic inventions; inventorship; invention type, e.g., where the invention type is selected from a group consisting of an apparatus, a method, an article of manufacture, a composition of matter, a functional invention and a business process invention; viewing an invention from multiple perspectives; the concept of relating an invention to the interests of an end user or a supplier; the concept of classifying an invention as breakthrough (pioneering), distinctive and incremental; licensing value, e.g., perceived monetary value of the invention; enablement; prior art and the significance that prior art has on the patentability of the inventions; and disposing of inventions, e.g., patenting the invention, publishing the invention with known inventors, publishing the invention anonymously, and maintaining the invention as trade secret.

In general, the invention provides a method of facilitating the conception of one or more inventions in target market and/or technology areas by a group of one or more participants, led by a facilitator, and may include the following steps: communicating basic concepts of patentability to the group of participants; training the group of participants on creativity and associative thinking methods; defining the target market and/or technology areas in which inventions are desired; and communicating guidelines for creative thinking to the participants.

### BRIEF DESCRIPTION OF THE DRAWINGS

FIG. 1 shows an example result of using the VIR/Forced Fit creativity tool.

FIG. 2 shows an example result of using the creativity tool IOD™.

FIG. 3 shows an example of selecting a problem and an element for IOD™.

FIG. 4 shows an example using a problem and an element to generate a seed of an idea using IOD™.

FIG. 5 shows an example using a problem and an element to generate a seed of an idea using IOD™.

FIG. 6 shows an example using generating a subordinate problem during an application of IOD™.

FIG. 7 shows an example using adding an additional element to address the subordinate problem during an application of IOD™.

FIG. 8 shows an example using adding supplementary descriptive material to an additional element to address the subordinate problem during an application of.

FIG. 9 shows an example using generating a second subordinate problem during an application of IOD™.

FIG. 10 shows an example using adding a second supplementary descriptive material to a second additional element to address the second subordinate problem during an application of IOD™.

FIG. 11 shows an example using adding a third supplementary descriptive material to a third additional element to address the third subordinate problem during an application of IOD™.

### DEFINITIONS

As used herein, the term “invention” means conceptual subject matter pertaining to (1) a useful product or process not previously known to the person(s) conceiving of the invention; or (2) a new use for an existing product or process, which use was not previously known to the person(s) conceiving of the invention. The term “invention” includes both patentable and non-patentable subject matter. It is noted that patentability is based on legal standards which vary with changes in law. Furthermore, patentability is premised on a legal analysis of the precise words of a patent claim and not on the degree of novelty of an inventive concept in general. The term “inventor” is used herein to refer to one who has solely or jointly conceived of an invention.

Unless specifically indicated, legal terms of art used herein (e.g., product, process, novel, non-obvious, utility, enable and the like) should be understood in their broadest sense, as encompassing not only strict legal definitions, but also encompassing ordinary meaning that would be attributed to the term by one with no specialized knowledge of patent law.

### DETAILED DESCRIPTION OF THE INVENTION

The Invention on Demand® (IOD™) method of the invention relates to a method for facilitating conception of inventions. The IOD™ method is particularly useful for facilitating conception of inventions in predetermined target technology fields and/or market spaces.

In a related aspect, the IOD™ method includes steps for sorting and prioritizing inventions thus conceived and assisting an organization in making rational business decisions relative to the inventions conceived according to the general IOD™ method. This aspect of the invention is useful, for example, in facilitating decisions related to the allocation of resources among multiple inventions, such as decisions relating investment of time, money and other resources in further research or in the preparation, filing and prosecution of patent applications.

The IOD™ method employs creativity tools to stimulate inventive processes that are native to each participant in the IOD™ session. Participants in an IOD™ session can be any combination of individuals with sufficient technical, business or consumer knowledge, or other kinds of knowledge, sufficient to permit the individuals to contribute to the inventive process. Preferably, the participants include individuals with sufficient technical knowledge to contribute to solving a technical problem in a specific technical area. The knowledge level of participants will vary depending on the nature of the technical area, ranging from ordinary consumers for invention of simple consumer products of minimal complexity to highly trained specialists for technical invention in fields such as electrical engineering, chemistry or biotechnology. Moreover, a single IOD™ session may involve participants with a variety of technical and/or non-technical skill sets. For example, a session may involve a combination of chemical, biological, electrical and other experts where the IOD™ session is targeting inventions in which such technical areas converge (e.g., DNA chip technology, high throughput drug screening technology, nanotechnology, etc.). As another example, it may be useful to combine business experts and/or consumers (who can provide problems or desires) with technical experts (who can provide technical solutions addressing the problems or desires).

While this ensuing discussion refers to the typical situation in which the IOD™ method is used with a group of participants, it will be appreciated that the method can be used with just one participant as well.

The IOD™ method involves any one or more, preferably all, of the following steps:

1. conveying information to participants regarding the concept of “invention”;

2. training participants in creativity and associative thinking methods;

3. identifying and/or defining the business or technical area(s) in which inventions are desired;

4. practicing creative/inventive problem solving techniques to facilitate conception by the participant(s) of one or more inventions;

5. assessing the inventions to identify the most valuable inventions; and

6. submitting descriptions of the invention(s) and the assessment of the value of the invention(s) to an individual or group (e.g., a manager, a management team, an invention review committee, a scientific advisory board, a board of directors, etc.) for further assessment.

### Conveying Information to Participants Regarding the Concepts of Relating to “Invention”

In the IOD™ method, the participants are preferably trained to understand concepts relating to invention, general, business and/or legal concepts relating to inventiveness, creativity, creativity tools, novelty, nonobviousness, enablement, utility, written description, enablement, reproducibility, types or classes of invention, etc. In the preferred embodiment, participants are provided with basic information regarding one or more, preferably all, of the following concepts:

1. legal and/or general concepts relating to the definition of an invention, e.g., patentability (novelty, non-obviousness or inventive step and utility) and bar dates;

2. concepts relating to creativity tools, such as the ladder of abstraction concept;

3. legal and/or general business concepts relating to publication of inventions, such as publication to obtain freedom of action or patenting a basic invention and publishing incremental improvements to the basic invention;

4. legal and/or general concepts relating to inventorship;

5. legal and/or general business concepts relating to invention types, for example, categories of inventions as defined by law (e.g., apparatus, method, article of manufacture, composition of matter, and business process invention) or categories of inventions defined by business or market concepts;

6. the concept of viewing invention of one invention type from the perspective of another invention type (e.g., viewing an apparatus from a method perspective, or a method from an article of manufacture perspective, etc.);

7. the concept of viewing an invention from the perspectives of various entities involved in the manufacture, sale and/or use of the invention (referred to herein as “invention views”), e.g., how the invention relates to technical capabilities or business objectives of an entity with a proprietary interest in the invention, how the invention relates to the end-user or the supplier of needed components of the invention, etc.;

8. the relationship of intellectual property strategy to invention, e.g., information regarding business and/or legal advantages and disadvantages of (a) patenting, (b) publishing with known inventors or affiliations, (c) publishing anonymously, (d) maintaining an invention as trade secret, and (e) requiring further development, and the like;

9. concepts relating to the class of invention, i.e., whether the invention is breakthrough (pioneering), distinctive or incremental;

10. licensing value, i.e., economic notions relating to the value of the invention, such as notions relating to the perceived dollar value of the invention;

11. area of invention, i.e., whether the invention is a technology, a basic technology or core competency that is used to create a variety of products, or is used as a basis for research and development, a product or a business matter;

12. functional dependence of invention on problems, elements, and “how” the invention works;

13. legal and/or business concepts relating to enablement of an invention; and

14. legal and/or business concepts relating to prior art, e.g., the significance that prior art has on the patentability and/or marketability of an invention.

### Training Participants in Creativity and Associative Thinking Methods

Invention can be thought of as a function of (a) one or more problems, (b) one or more elements, and (c) one or more “hows.” The term “hows” is used herein to refer to precise way(s) in which elements of an invention are interrelated and operate.

Creativity can be viewed as an exercise in associative thinking. Associative thinking, when used as a deliberate creativity tool, involves the consideration of the attributes of two (and sometimes more) items, and either systematically or randomly linking the items. For example, consider a subject presented with a violin and brick. The subject might identify the violin attributes of strings, frame, sound, resonance, and tuning, and might identify the brick with attributes of rough surface, heavy, ceramic, and porous. If resonance and ceramic are combined, the subject might conceive of a house or other structure containing integral resonant cavities tuned to emit melodious sound. Other combinations of violin and brick attributes would lead to other and perhaps more interesting ideas.

When applied to the invention process, the “items” are problems, elements, and hows. The hows are derived by expressing one or more problems in a positive interrogatory format (often denoted by “H2,” shorthand for “how to”). For example, consideration of the problem that a company's product breaks too often, might result in any of the following positive interrogatory statements:

“H2 keep the product from breaking?”

“H2 increase the mean time between failures?”

“H2 make it stronger?”

A specific problem can result in many conceivable H2 statements, each of which can be used with an element to create an invention. Furthermore, the nuance of the phrasing of the H2 statements can be used to steer the inventive process.

Random linkages create undirected inventions. By selecting a linkage with specific intent, the association becomes directed. When applied to the inventive process, directed association results in invention in specific technical or market areas. In the IOD™ method, a participant can use the associative thinking methodology to systematically generate hundreds of problems and hundreds of elements. From these hundreds of problems and elements the IOD™ method employs directed creativity to generate inventions in specific areas. In other words, the IOD™ method results in invention at will.

### Identifying and/or Defining the Business or Technical Area(s) in Which Inventions are Desired

A successful IOD™ session results in inventions that meet predefined criteria. The criteria are usually expressed using a positive, idealistic stem in the form of a mess statement. One such stem is “Wouldn't it be nice if . . . ” The criteria may be determined by discussion between a session facilitator and one or more participants or someone with a proprietary interest in the results of the IOD™ session.

As an example, consider a hypothetical situation in which the Pick Up & Move Wheelbarrow Company has decided to enter a new market. Market research has revealed that an impending construction boom will lead to the construction of many skyscrapers. Presently available technology requires construction workers to carry the large bolts employed in high-rise construction in buckets by hand. Existing wheelbarrows are unsuitable because they cannot be manipulated conveniently on the steel girders of a skyscraper. Moreover, they are prone to tipping over, making them a severe safety hazard. Given this scenario, a mess statement that might be generated is: “Wouldn't it be nice if we had a wheelbarrow that was suitable for application in high-rise construction?”

### Practicing Creative/Inventive Problem Solving Techniques to Facilitate Conception by the Participant(s) of One or More Inventions

Many known creativity/problem solving tools can be used to stimulate inventive thought. It is therefore important, when conducting an IOD™ session, to select a tool that will lead to a successful IOD™ session. Expression of creativity varies among individuals. According to Kirton's theory, this variation can be viewed as a continuum ranging from the highly adaptive to the highly innovative, with most people possessing a mixture of adaptive and innovative creativity styles. The response of any given individual to a given creativity tool depends in part on the type of stimulation provided by the tool. Consequently, when working with more than one or two people in an IOD™ session, it is important to use several creativity tools and to use diverse creativity tool styles to elicit creative thought from every participant. In a typical IOD™ session, the first tools used should target individuals with a mixture of adaptive and innovative creativity styles (i.e., those individuals in the middle of the continuum). Subsequently, tools are selected that target the more adaptive or more innovative individuals.

In selecting creativity tools according to the IOD™ method, it is also important to consider the type of invention desired. Incremental inventions are adaptive by nature so adaptive-style tools are preferred. Similarly, innovative inventions are innovative by nature so innovative style tools are preferred.

Creativity tools can be further categorized as being of a diverging nature or of a converging nature. Diverging tools stimulate the conception of multiple new possibilities. Converging tools encourage participants to focus on final solutions.

Examples of diverging creativity tools useful in the IOD™ method of the invention are as follows, listed from adaptive to innovative:

1. Interactive brainstorming with sticky notes;

2. Silent brainstorming with sticky notes;

3. Visually Identifying Relationships (VIR); and

4. Forced fit (uses objects as a stimulus).

In a session involving interactive brainstorming with sticky notes, participants write ideas on a sticky piece of paper, such as a Post-It® (3M). In a typical session, the participant verbally expresses the idea immediately before, immediately after or as he or she writes the idea on the sticky note. The sticky note is then posted on a surface, such as a flip-chart or white board, preferably by a facilitator. In this interactive approach, each participant has the opportunity to benefit from the creative stimulus of ideas generated by other participants.

In the silent brainstorming with sticky notes approach, participants are provided multiple sticky pieces of paper, such as a Post-It® (3M) (generically referred to herein as “sticky notes”), and a writing utensil, preferably a broad-tipped, colored marker. Participants individually generate ideas for a predetermined period of time (typically 5-30 minutes) and write one idea per sticky note. Each sticky note is then placed (e.g., by a facilitator) on a surface (e.g., a flip chart or white board) viewable by the participants. In this silent approach, participants benefit from the silence, which permits each participant to concentrate on conception of new ideas without distraction from other participants. This method is particularly effective with introverted participants.

Visually Identifying Relationships (VIR)/Forced Fit is a creativity tool in which participants are handed an object. The object can be of practically anything, and can range from a picture to a collection of objects, e.g. children's toys. Participants are then asked to identify attributes of the object and then use the attributes as stimuli to generate problem statements in the form of “how to?” type questions. In a preferred embodiment, each participant can identify associations between the problem statements and the attributes identified by the participant and/or other participant(s). This exercise can lead to very innovative inventions.

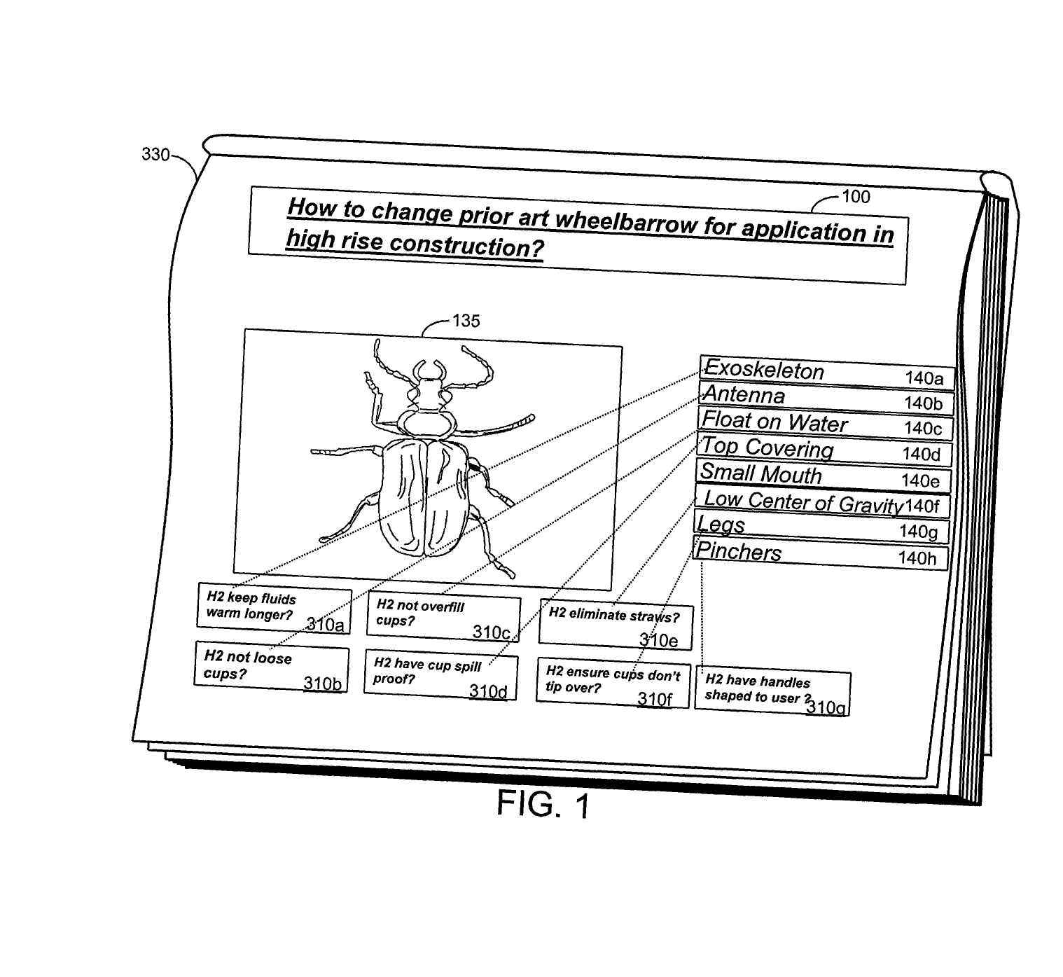

FIG. 1 demonstrates the results of using the VIR/Forced Fit creativity tool in this example, examination of a toy bug 135 has led to a list of toy bug 135 attributes 140a-140h which are used to generate problem statements 310a-310g.

Thus, toy bug 135 attribute “exoskeleton” 140a has been used as stimuli to generate problem statement 310a “how to keep fluids warm longer?” The tactile, visual and olfactory sensations associated with the object stimulate different thought patterns that lead to the generation of problem statements. It will be appreciated that sound can also be used in this manner.

It will be appreciated that the foregoing creativity tools represent a sampling of the known diverging creativity tools. Other diverging creativity tools may also be used within the scope of the invention.

The diverging tools are used to generate a multiplicity of ideas. When sufficient ideas have been generated, the IOD™ method switches to the use of converging tools. The determination that sufficient ideas have been generated can be made in a variety if ways. For example, the determination may be made by the facilitator, by one with a proprietary interest in the results of the IOD™ session, and/or by one or more of the participants. Alternatively, the diverging portion of the session may end when a predetermined number of ideas have been generated or after a fixed period of time has elapsed.

Examples of converging tools useful in the IOD™ method of the invention include: hits and highlighting; multi-voting; categorizing/use multi-voting; IOD™ and adding more enablement.

One way to identify valuable solutions to a problem is to use a multi-vote system. All of the available options can be pooled, and participants may select specific items. The selection process may be governed by specific rules, e.g., “Select the option which provides the best solution to the mess statement.” Alternatively, selection may also be accomplished without such rules, allowing participants to choose on any basis selected by the participant, such as gut feeling, reasoned professional opinion, or simple consumer likes and dislikes. The preferred selection indicator is a sticky colored dot (which can be in any shape) that is readily visible to all of the participants. Voting can be accomplished according to any of the many known systems for voting. For example, a participant can be given a limited number of dots and permitted to select a solution with each dot. In other systems, participants may provide additional weight to their vote by using more than one dot on a single solution. Moreover, multicolored dots can be used to permit participants to vote on more than one attribute of the solutions, e.g., simplicity, potential consumer acceptance, cost of research and development, cost of manufacture, alignment with business plan, etc.

In the preferred embodiment, multi-vote convergence is accomplished as follows:

1. Determining selection criteria in a discussion including the facilitator, the assignee's representative, and the participants;

2. Distributing selection indicators to the participants; and

3. Participants selecting preferred solutions and identifying their selections by placing a sticky dot on the sticky note.

It is common for participants to generate a tremendous number of options. If the number is particularly large (e.g., 50 or more), it can be difficult to apply multi-voting alone without overlooking potentially significant options. Moreover, in some circumstances, the nature of the mess statement may be sufficiently general that possible acceptable solutions may fall into several categories. For both of these circumstances, the method of defining categories and using multi-voting can be very effective. This method generally includes: identifying suitable categories; collecting the sticky notes into groups corresponding to the categories; using multi-vote convergence to identify the preferred group.

The result of multi-voting or defining categories using multi-voting can result in some very good ideas. However, as inventions, they are not always fully enabled. In such circumstances, IOD™ can be used to effectively elicit further enabling information from the participants.

In the preferred embodiment, the IOD™ further includes the following steps:

1. Placing the sticky notes representing the collection of “best” options on a support, such as a flip-chart;

2. Identifying a seed of an idea;

3. Identifying a subordinate problem or limitation of the current state of development of the invention;

4. Improving the invention by solving the subordinate problem;

5. Repeating steps 2-3 until a satisfactory basic concept has been identified.

IOD™ leads to new inventions, and they can be as adaptive or as innovative as the situation demands. However, sufficient information may not yet be present to permit manufacture or operation of the invention in the absence of additional conceptual input. For example, referring to the wheelbarrow example discussed in the preceding section, as the invention stands (in the form of improved seed 176d of an idea), it is still not a manufacturable product, so additional creativity must be applied.

In some circumstances, it may be useful to undergo a diverging creativity process once more before converging on specific solutions. To do this, any of the diverging tools may be used. Upon completion of the diverging step, the converging tools are used to focus on a particular solution. In some cases specific creativity tools are not necessary; existing experience is enough to indicate what appropriate enabling steps are needed.

In this aspect of the invention, the IOD™ method includes one or more of the following steps:

1. Reviewing guidelines for creative thinking;

2. Reviewing the mess statement;

3. Listing data relevant to the mess statement (Data finding);

4. Listing problems relevant to the data (Problem finding);

5. Listing elements relevant to the data (Element finding);

6. Applying one or more creativity tools to generate inventions;

7. Sharing the inventions with the other members of the IOD™ session; and

8. Expanding each invention to broaden it and determine a path to full enablement.

Each of the foregoing steps is discussed in the ensuing subsections.

### Communicating Guidelines for Creative Thinking

The guidelines for creative thinking are selected to foster creativity and inventiveness. In the preferred embodiment, there are two sets of guidelines, one for generating options and a second set for focusing options.

Examples of option-generating guidelines include: deferring judgment; striving for quantity; freewheeling; and seeking combinations (i.e., building on others' ideas).

Deferring judgment directs the participants to eliminate premature judgment of ideas. Remarks such as “that'll never work” or sarcasm suppress the spontaneity of the creative process. Even positive comments should be avoided, since they can bias the participants in a particular direction especially if made by a manager or technical leader present. Also, ideas that are not praised directly as being positive are implicitly negative.

Striving for quantity directs the participants to seek many ideas rather than just the handful that might work. It is far better to have hundreds of ideas from which to choose rather than being limited to just one or two.

Freewheeling directs the participants to be open-minded, even to the point of suggesting apparently outlandish ideas. Though the outlandish idea may eventually be discarded, it may serve to stimulate someone to come up with one or more other ideas that are not considered ridiculous.

Seeking combinations encourages participants to be inspired by combinations of ideas, and to use ideas being suggested by others in the group as a source of inspiration to come up with yet other ideas.

Examples of option-focusing guidelines include: using affirmative judgment; being deliberate; and staying on course.

Participants are directed to use affirmative judgment, especially by directing participants to encourage each other and to look for solutions to problems rather than looking for problems.

Remarks such as “that'll never work,” or sarcasm suppress the spontaneity of the creative process. Even when being critical, it is important to do so in a positive way. For example, rather than say, “That won't work!” one can suggest, “Interesting idea. It is provoking a lot of thoughts in me. A question that comes to mind is how would you deal with (fill in the problem)?”

Participants are preferably instructed to be deliberate in their use of the structure of the IOD™ tools and the creative problem solving process to reach solutions.

Participants are preferably directed to stay on course by acknowledging the need to reach solutions and to avoid wandering off on a creative “wild goose chase.”

These guidelines are preferably reviewed immediately prior to exercising the creative/inventive problem solving tools, and later on during the session as needed.

### Reviewing the Mess Statement

The mess statement is preferably reviewed to ensure that all of the participants understand the objective of the IOD™ session. This review process also ensures that the facilitator and the assignee are in agreement as to the subject matter of the session.

### Listing Data Relevant to the Mess Statement (Data Finding)

In this phase of the IOD™ session, miscellaneous facts, data and relevant attributes pertaining to the mess statement are summarized. Methods of listing the data include the use of the moderator writing the data on flip charts, interactive brainstorming with sticky notes and silent brainstorming with sticky notes.

### Listing Problems Relevant to the Data (Problem Finding)

In this phase of the IOD™ session, participants use the miscellaneous facts, data and relevant attributes pertaining to the mess statement as stimuli to identify problem statements. Methods for producing the problem statements include the use of diverging tools such as interactive brainstorming with sticky notes and silent brainstorming with sticky notes. An alternate way to practice the diverging tools method is for the moderator to omit the sticky notes and simply write the data on the flip charts directly.

### Listing Elements Relevant to the Data (Element Finding)

In this phase of the IOD™ session, participants use the problem statements as well as the miscellaneous facts, data and relevant attributes pertaining to the mess statement as stimuli to identify elements. Methods for producing the problem statements include the use of diverging tools such as interactive brainstorming with sticky notes and silent brainstorming with sticky notes, VIR and Forced Fit.

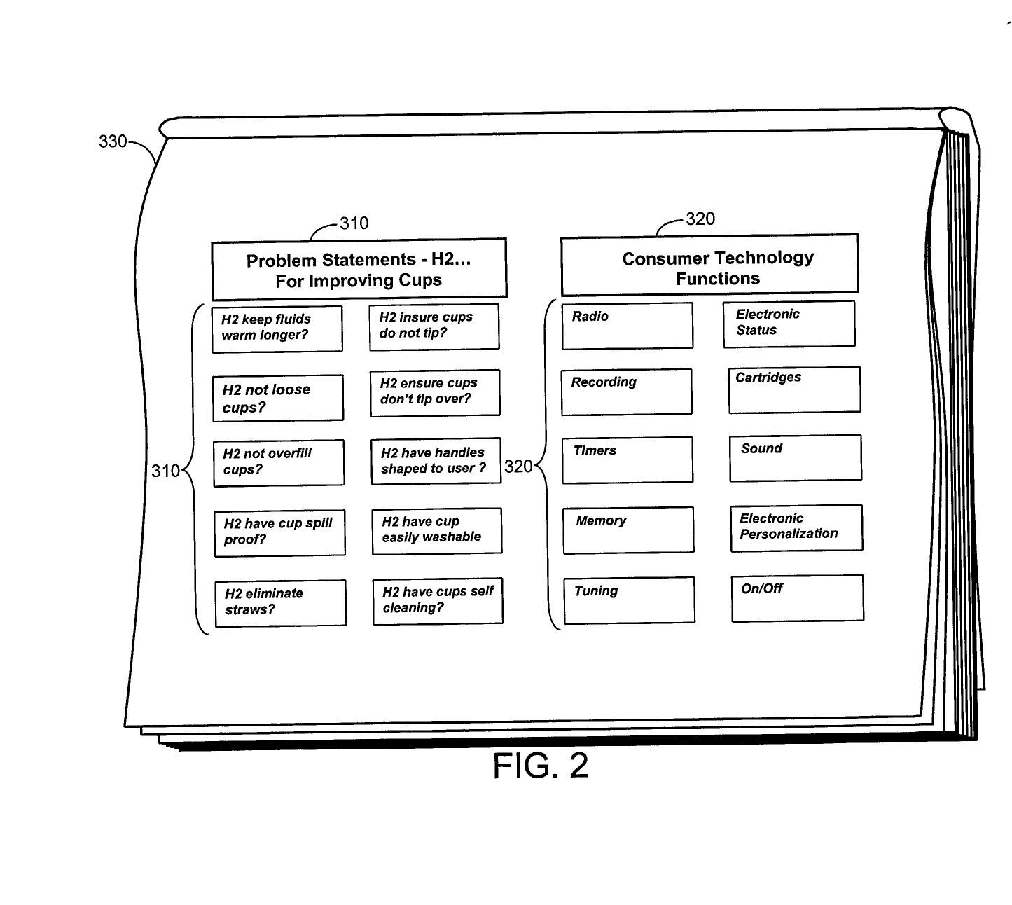

FIG. 2 shows an example of the outcome of a Problem Finding session and an Element Finding session displayed on flip-chart 330. The objective of the session is to invent a new cup on the premise that the IOD™ session is being conducted for a company in the cup business, and that competitors in the existing cup market are aggressively penetrating the market so the company needs to develop a new market. On the left side of flip-chart 330 is Problem Statements 310, and on the right side of the figure are Element Statements 320, where the Element Statements 320 have been chosen to be consumer technology functions.

### Applying One or More Creativity Tools to Generate Inventions

When asked to invent, IOD™ participants are given a flip-chart sized piece of paper that has been folded in half, and a broad-tipped, colored marker, such as a Sharpie™ , where each color is specific to each participant. The use of different colored pens serves to identify inventorship. The participants are asked to use the top half to develop their invention and given 10 to 15 minutes to do so. Each participant uses a combination of a problem and an element as a seed to stimulate an invention. In the allotted time, each participant expresses his solution to the problem using the chosen element in terms of sketches, drawings, figures and text.

In this phase, the IOD™ method involves selecting preferably two, but occasionally three or more, items from the list of problems and elements to use as a seed for generating an invention. The preferred method involves the selection of one problem statement and one element. This process is done three or more times, depending on the time available. During the first period of invention, the participants are asked to pick their own problem and element. The novelty of invention during this period is generally low. During the second period of invention, the participants are asked to pick a problem and element pair for someone else. The novelty of invention during this period is generally moderate to high. During the third period of invention, the participants are asked to pick a problem and element pair at random. The novelty of invention during this period is generally high.

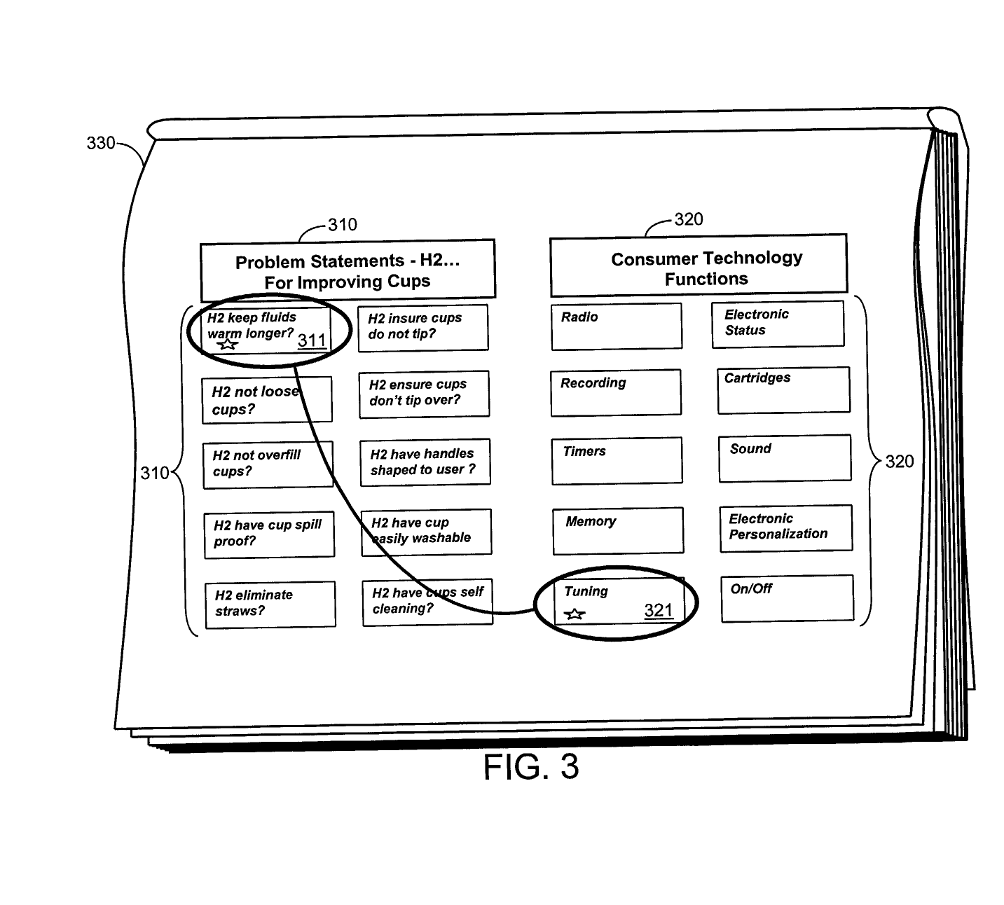

FIG. 3 illustrates the results of the first step of this process displayed on flip-chart 330. This figure includes the problem statements 310 and the elements 320, and shows the selection of a particular problem statement (problem statement 311) and a particular element (element 321).

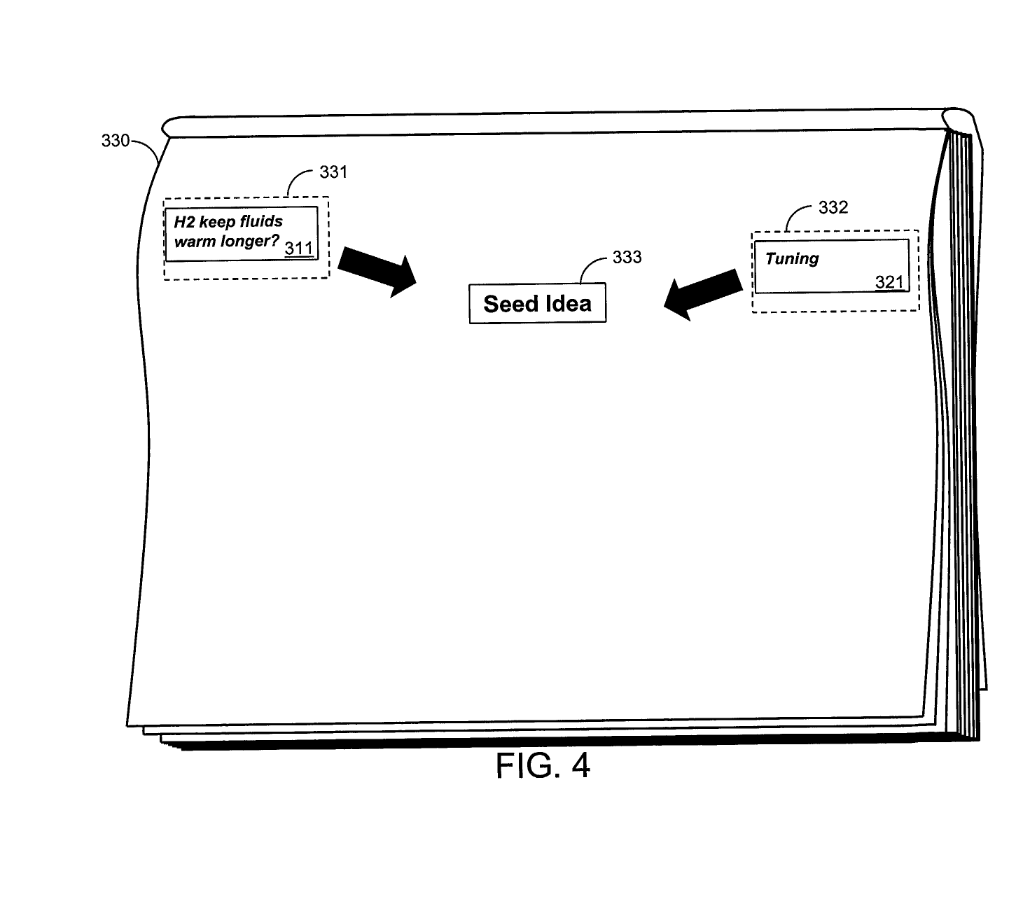

Problem statement 311 and element 321 are posted on a page of flip-chart 330, as depicted in FIG. 4, preferably so that the problem statement 311 is in the upper left hand comer 331 of flip-chart 330 and the element 321 is in the upper right hand corner 332 of flip-chart 330. The participant uses problem statement 311 and element 321 to develop a seed idea 333.

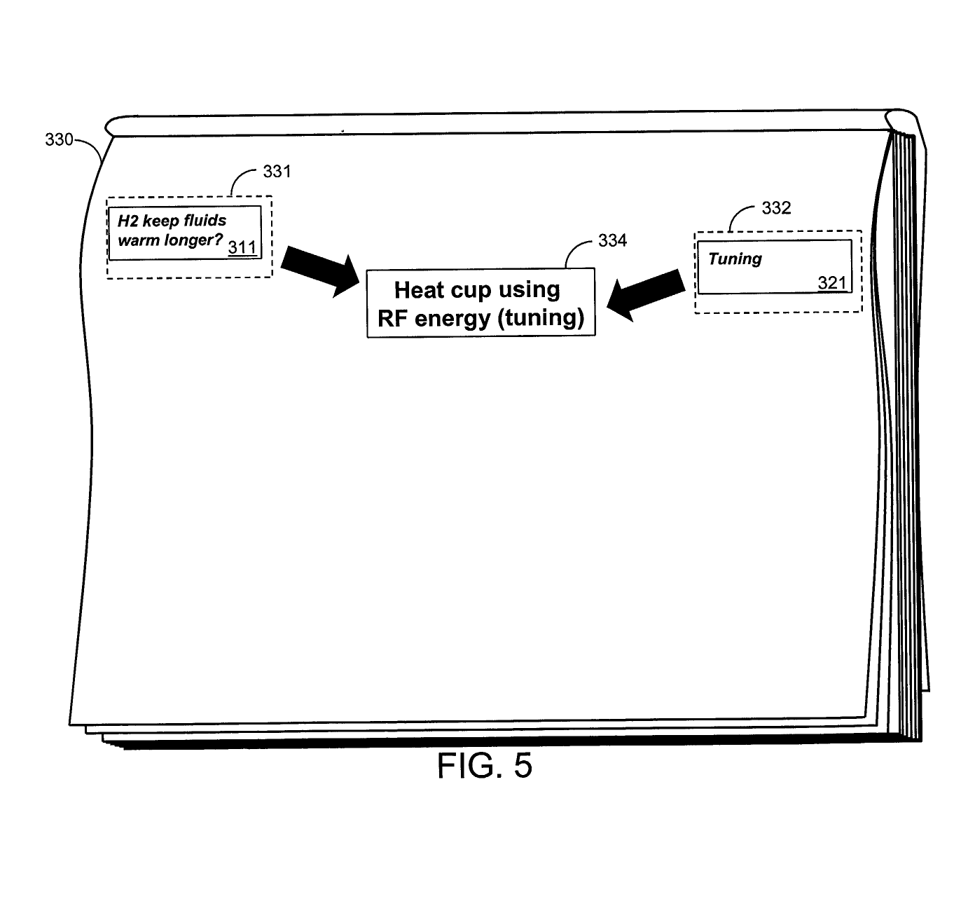

FIG. 5 shows, an example of this process displayed on flip-chart 330. Problem statement 311 consists of “H2 keep fluids warm longer?” and element 321 consists of “Tuning.” The participant puts the problem of keeping fluids warm using tuning to come up with a seed idea 334 “Heat cup using RF energy (tuning).”

### Sharing the Inventions with Other Members of the IOD™ Session

At the conclusion of each invention period, each participant in turn hangs his flip-chart sized piece of paper with his invention for the other participants to view, and he explains his invention. Typically, the inventions are not thoroughly developed, and sometimes only part of the solution is present.

### Expanding Each Invention to Broaden it and Determine a Path to Full Enablement

At this point the facilitator leads the other participants to identify ways to improve the invention using positive questions. For example, instead of stating that a given invention will never work, the facilitator teaches the participants to ask instead, how would you deal with (whatever the problem is). These problems are called subordinate H2 (how to) problems. If a second participant has a response for the concern expressed by a first participant, the second participant's colored pen is used to capture the response.

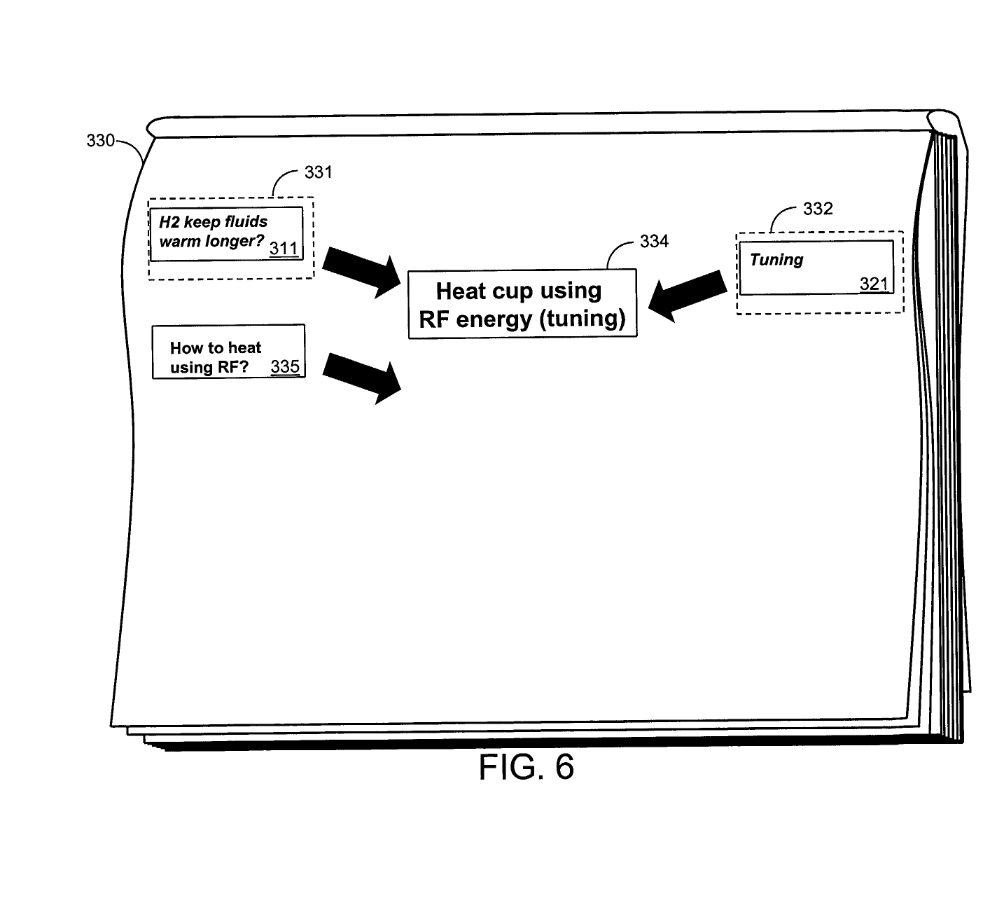

As an example of this part of the process, a participant raises the question, how would you heat the cup using RF energy? This question becomes subordinate problem statement 335 in FIG. 6. FIG. 6 shows how subordinate problem statement 335 would be written on a sticky note and stuck on the flip-chart 330 below problem statement 311. By sticking subordinate problem statement 335 below problem statement 311, room is left for one of the participants to present a solution to subordinate problem statement 335.

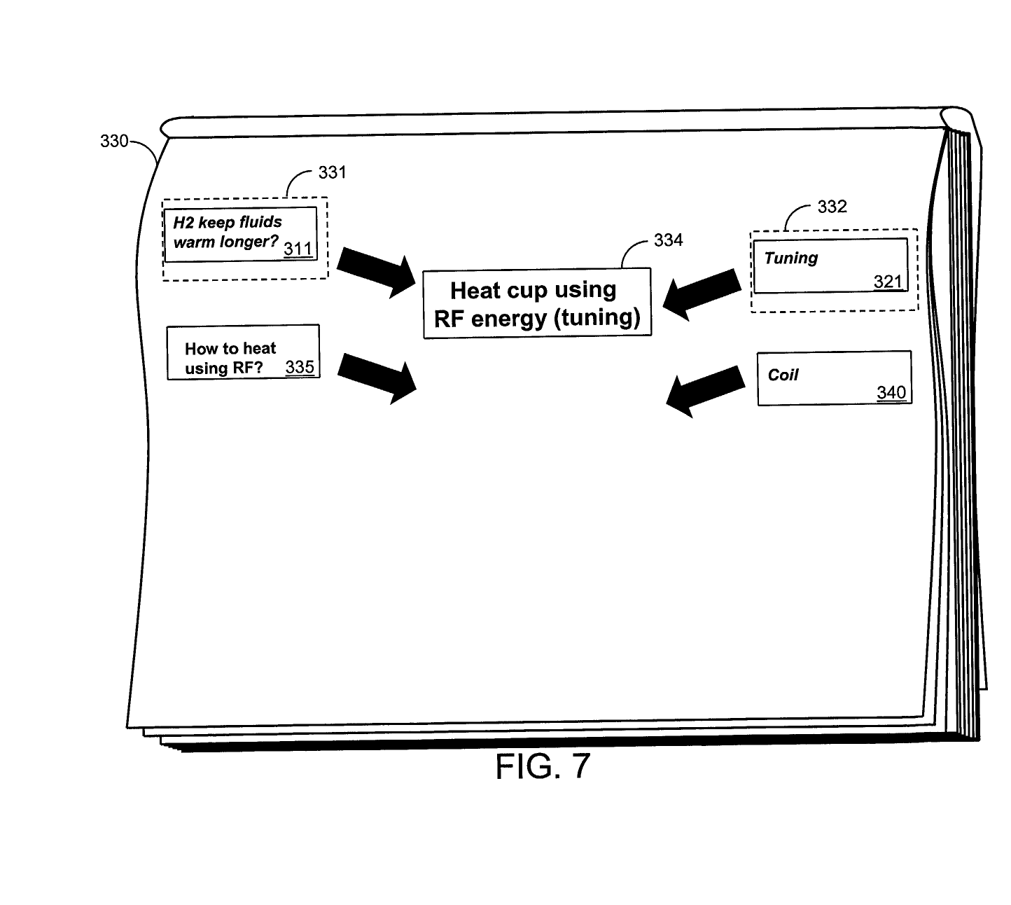

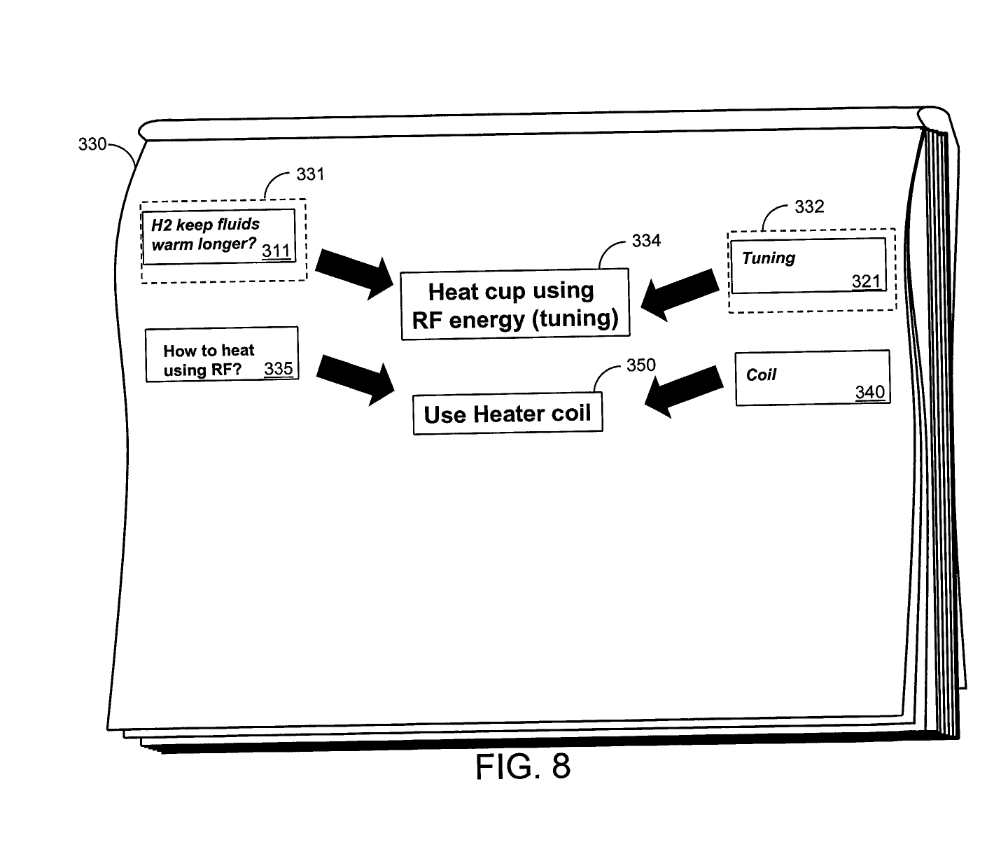

One of the participants then thinks of a solution to subordinate problem statement 335 and describes it using pictures, diagrams, flow charts and phrases, all supplemented with a verbal description of his solution. FIG. 7 shows a portion of the result of finding the solution to subordinate problem statement 335. In this case, the solution to subordinate problem statement 335 involves the additional element of a coil 340, which is noted in FIG. 7. Other pictures, diagrams and flow charts can be used to illustrate the relationship of the solution to subordinate problem statement 335. FIG. 8 shows improved seed 350 to solve problem statement 335 using element 340.

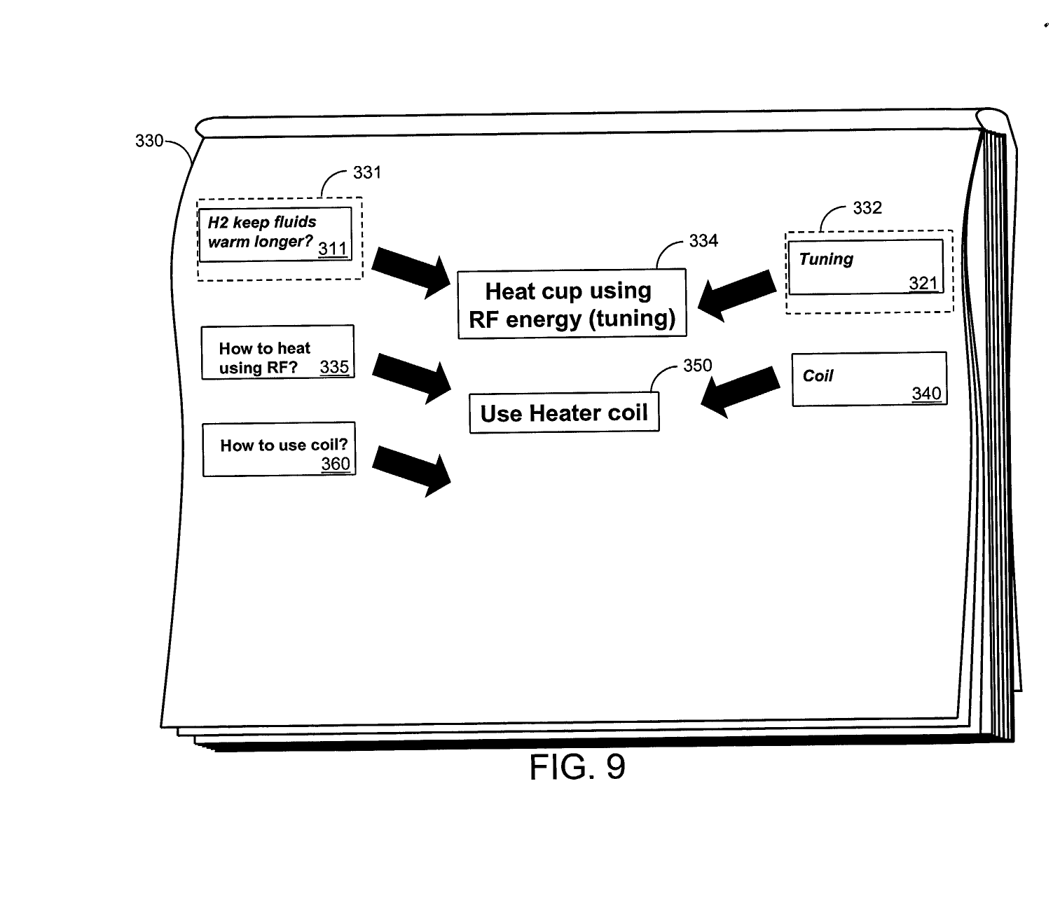

Referring to FIG. 9, one of the participants identifies another problem, how to use the coil 360. He presents his problem as subordinate problem 360, which is stuck on the flip-chart 330 below subordinate problem 335.

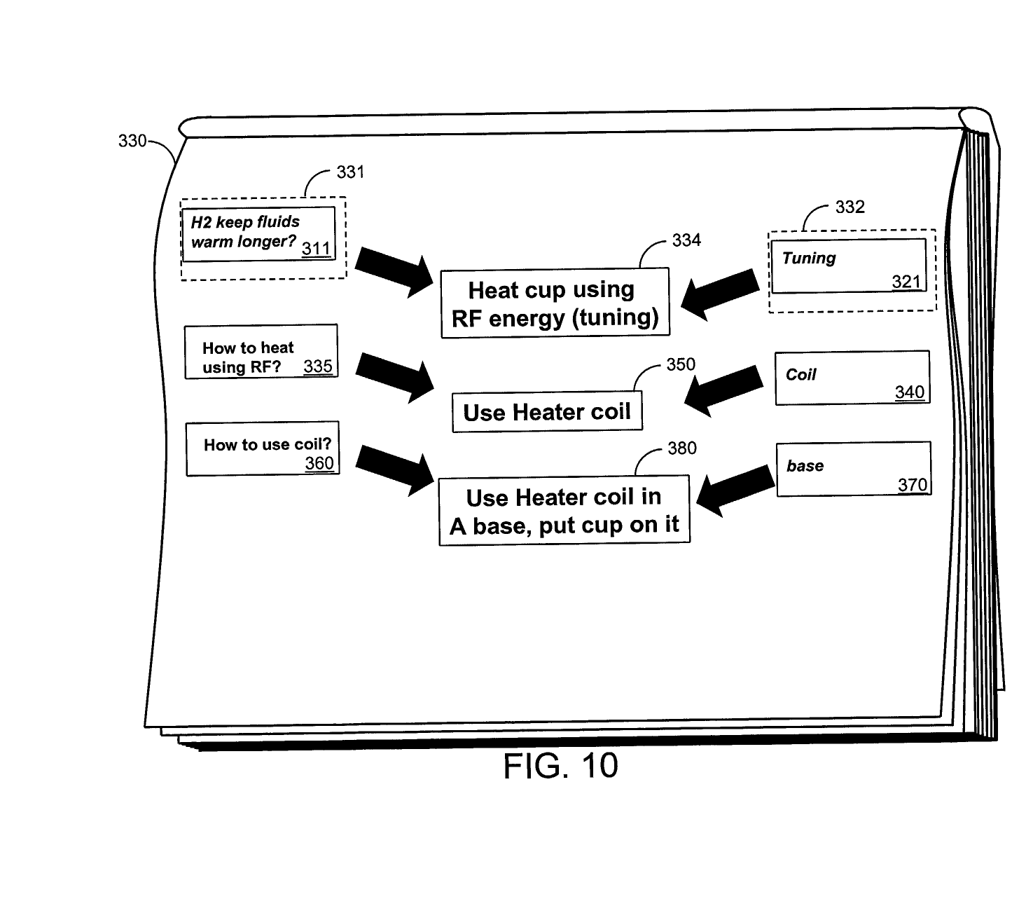

The posing of subordinate problem 360 prompts one of the participants to think of a solution and he presents his solution as the addition of a new element, a base 370 in which to put the coil 340. By applying energy to the coil 340, the base 370 will heat up, and the cup can be placed on the base to keep the fluid warm longer which is seed 380 as shown in FIG. 10.

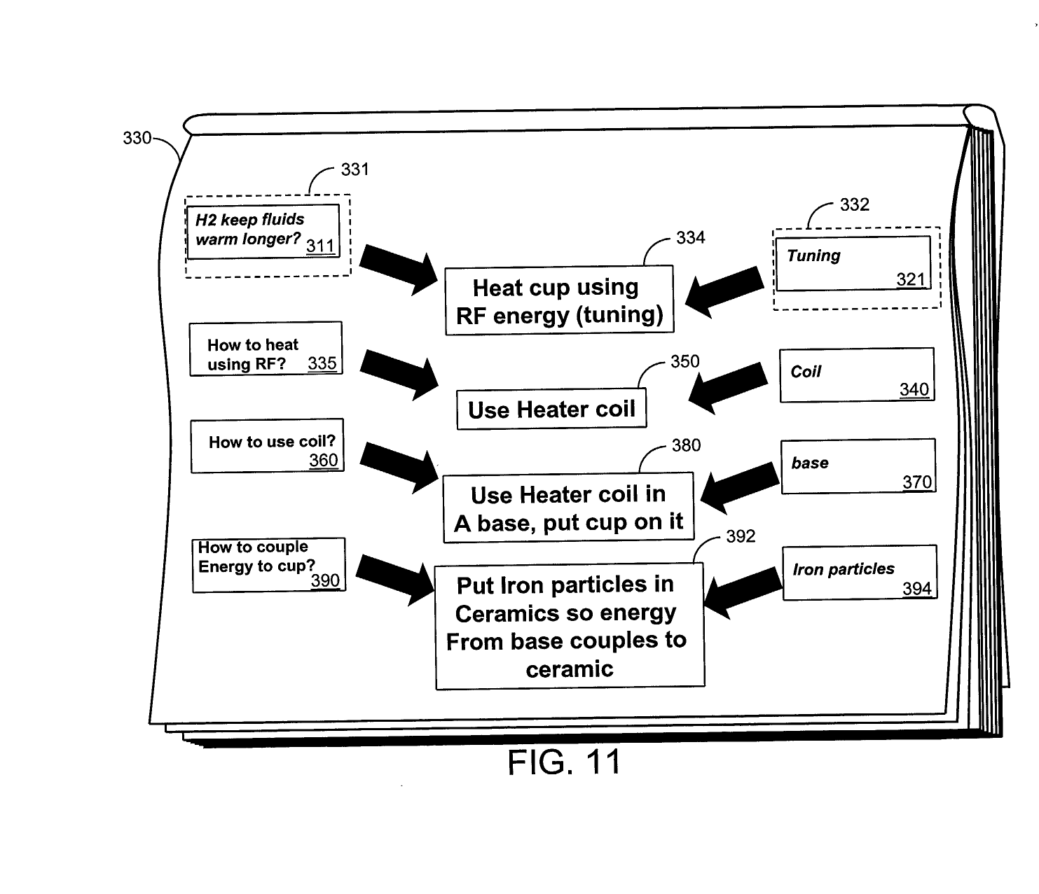

Yet another participant points out by asking, problem statement 390 “how do you couple energy to the cup?” This subordinate problem 390 is stuck on flip-chart 330 beneath subordinate problem 360, as shown in FIG. 10. One of the participants proposes adding yet another element, iron particles 394. Participants' description of how to use iron particles 394 is put on flip-chart 330 as description 392 as shown in FIG. 11.

At this point the facilitator interrupts, pointing out that the invention has been reasonably well described. Further details will be necessary, but the basis for the invention is well laid out.

During this phase of the development of inventions, the inventions are developed to include broad solutions. The idea is to capture the basic idea of the inventions, along with sufficient information about what is needed to fully enable it. The invention can be more fully developed later on, but at this point it is not known which inventions will be the most valuable, and the objective is only to come up with as many inventions as possible.

One way to expand the inventions is to use a Round-Robin Invention Expansion method. In this method, all of the inventions are posted around the room where the IOD™ session is being held, and all of the participants peruse the new inventions. With each invention, participants write (using their distinctive color) a subordinate H2 problem statement on the original participant's flip-chart description of an invention. He may also add a solution to the subordinate H2 problem. He may further add alternative embodiments of an invention.

### Assessing the Inventions to Identify the Most valuable Inventions

At the end of the IOD™ session, the participants are asked to assess the inventions. In an 8-hour period with 6 to 8 participants, 20 to 40 inventions can be created. The participants generally have enough experience to provide some guidance as to which inventions have the greatest value.

There are several ways to assess the inventions. One of the simplest ways involves the use of voting. The facilitator asks the participants to write down on a piece of paper their top choices. The facilitator has considerable latitude in selecting how many inventions the participants may select as a top choice. If it is apparent that there are many inventions and that many of them are good, then the facilitator will ask the participants to pick their top 5 or so inventions. If there are fewer inventions, the facilitator will ask the participants to identify fewer inventions, e.g. their top three.

For cases in which the success criteria include more than one measure, the facilitator provides the participants with several groups of colored dots. Each dot is assigned a success criterion, and the participants are asked to vote as before, this time with each of the different colors.

### Submitting Descriptions of the Invention(s) and the Assessment of the Value of the Invention(s) to Management Review

The IOD™ method also includes submitting inventions for management review. The inventions are preferably submitted after they are ranked by the participants who participated in some or all of the IOD™ session in which the inventions were invented. Preferably, the inventions are tallied, and results are delivered to the assignee representative for further assessment by another individual or group (e.g., management) for decisions regarding the disposition of the inventions.

### Conclusion

The many features and advantages of the invention are apparent from the detailed specification. Thus, it is intended by the appended claims to cover all such features and advantages of the described methods that follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents should be considered as falling within the spirit and scope of the invention.

What is claimed is:

1. A method of facilitating the conception of one or more inventions in target market and/or technology areas by a group of one or more participants, the method comprising:
(a) a set of one or more steps accomplished by a facilitator, comprising one or more steps selected from the group consisting of:
(i) communicating guidelines for creative thinking to the participants wherein the guidelines for creative thinking comprises creativity tools; and
(ii) facilitating any one or more of steps (b)(i) to (b)(vi); and
(b) a set of one or more steps accomplished by the participant(s), the set of steps comprising one or more steps are selected from the group consisting of:
(i) conceiving of and establishing a mess statement;
(ii) conceiving of facts, data, and/or relevant attributes relevant to the mess statement;
(iii) conceiving of problem statements related to the mess statement, wherein the problem statements are identified using creativity tools and/or creative stimuli comprising one or more of the facts, data, and/or relevant attributes identified in step (ii) as creative stimuli;
(iv) conceiving of elements of solutions to the problem statements, wherein the elements are conceived using creative stimuli comprising stimuli selected from the group consisting of:
(1) one or more of the problem statements conceived in step (b)(iii); and
(2) one or more of the facts, data, and attributes of step (b)(ii) as creative stimuli;
(v) conceiving of inventions using one or more creative stimuli comprising stimuli selected from the group consisting of:
(1) one or more of the creativity tools communicated in step (a);
(2) one or more of the problem statements conceived in step (iii); and
(3) one or more of the elements conceived in step (iv); and
(vi) expanding one or more of the inventions conceived in step (v).

2. The method of claim 1 wherein step 1(b)(i) is accomplished by the participants and facilitated by the facilitator.

3. The method of claim 1 wherein step 1(b)(ii) is accomplished by the participants and facilitated by the facilitator.

4. The method of claim 1 wherein step 1(b)(iii) is accomplished by the participants and facilitated by the facilitator.

5. The method of claim 1 wherein step 1(b)(iv) is accomplished by the participants and facilitated by the facilitator.

6. The method of claim 1 wherein step 1(b)(v) is accomplished by the participants and facilitated by the facilitator.

7. The method of claim 1 wherein step 1(b)(vi) is accomplished by the participants and facilitated by the facilitator.

8. The method of claim 1 wherein the facilitator also acts as a participant.

9. The method of claim 1 further comprising assessing the inventions based on pre-determined criteria to identify a list of most valuable inventions.

10. The method of claim 1 further comprising communicating to a decision making group information about the inventions, the information comprising a ranking of the invention according to one or more business or technical criteria.

11. The method of claim 1 further comprising, prior to communicating guidelines for creative thinking, communicating basic concepts of patentable inventions to the first group of participants.

12. The method of claim 11 wherein said communicating basic concepts of patentable inventions to the first group of participants is accomplished by the facilitator.

13. The method of claim 11 wherein the basic concepts of patentable inventions subject matter concepts comprises one or more of the following:
(a) a concept of new, useful and non-obvious criteria of patentable inventions;
(b) a concept of a ladder of abstraction;
(c) a concept of bar dates of when a participant is entitled to obtain patentable inventions;
(d) a concept of publication as a means of obtaining freedom of action and of obtaining a low cost way of protecting basic inventions by patenting the basic inventions and publishing the incremental improvements around the basic inventions;
(e) a concept of inventorship;
(f) a concept of invention type, wherein the invention type is selected from a group consisting of an apparatus, a method, an article of manufacture, a composition of matter, a functional invention and a business process invention;
(g) a concept of moving an invention type from an apparatus to a method of invention, and an article that results from the method of invention;
(h) a concept of invention views, wherein the invention views comprise relating the invention to capability of an assignee of the invention, capability of an end-user of the invention, and capability of a supplier of the invention;
(i) a concept of class of invention, wherein the class is selected from a group consisting of breakthrough (pioneering), distinctive and incremental;
(j) a concept of licensing value, wherein the licensing value comprises a perceived monetary value of the invention;
(k) a concept of enablement;
(l) a concept of prior art, and significance that prior art has on patentability of the inventions; and
(m) a concept of disposing of the inventions, wherein the disposing of the inventions comprise at least one of the following patenting the invention, publishing the invention with known inventors, publishing the invention anonymously, and holding the invention as trade secret.

14. The method of claim 1 further comprising, prior to the communicating guidelines for creative thinking, training the first group of participants on creativity and associative thinking methods.

15. The method of claim 14 wherein the training of the first group of participants on creativity and associative thinking methods comprises one or more steps accomplished by the participant(s), the set of steps comprising one or more steps selected from the group consisting of:
(a) considering the one or more problem statements conceived in step 1(b)(iii), at least one element conceived in 1(b)(iv) and at least one “how to” question; and
(b) linking one or more problem statements conceived in step 1(b)(iii), one or more elements conceived in 1(b)(iv) and the at least one “how to” question.

16. The method of claim 1 further comprising, prior to the communicating guidelines for creative thinking, defining the target market and/or technology areas in which inventions are desired.

17. The method of claim 1 wherein the mess statement comprises:
(a) a wish stem; and
(b) a concise description of a desirable outcome to a problem that currently has no acceptable solution.

18. The method of claim 1 wherein the one or more problem statements conceived in step 1(b)(i) comprise “how to” type questions.

19. The method of claim 1 wherein the guidelines for creative thinking further comprise one or more of the following:
(a) generating options guidelines wherein the generating options guidelines are selected from the group consisting of:
(i) a deferring judgment guideline, wherein the first group of participants is asked to eliminate premature judgment of ideas;
(ii) a striving for quantity guideline, wherein the first group of participants is asked to seek many ideas;
(iii) a freewheeling guideline, wherein the first group of participants is asked to be open minded, even to the point of suggesting outlandish ideas; and
(iv) a seeking combinations guideline, wherein the first group of participants is asked to combine ideas and use ideas of other participants of the first group of participants to inspire new ideas; and
(b) focusing options guidelines wherein the focusing options guidelines are selected from the group consisting of:
(i) a using affirmative judgment guideline, wherein the first group of participants are asked to encourage other participants of the first group of participants to look for solutions to the problems rather than looking for new problems;
(ii) a being deliberate guideline, wherein the first group of participants are asked to use the structure of the creativity tool and a creative problem solving process to reach solutions to the problems; and
(iii) a staying the course guideline, wherein the first group of participants are asked to acknowledge the need to reach solutions to the problems, and to avoid wandering off on creative tangents.

20. The method of claim 1 wherein the creativity tools comprise one or more of the following:
(a) divergent tools wherein the divergent tools are selected from the group consisting of:
(i) interactive brainstorming;
(ii) silent brainstorming;
(iii) visually identifying relationships (VIR)/Forced Fit; and
(b) convergent tools wherein the convergent tools are selected from the group consisting of:
(i) Multi-Voting;
(ii) categorizing/use multi-voting;
(iii) IOD™ ; and
(iv) adding more enablement.

21. The method of claim 20 wherein the interactive brainstorming comprises:
(a) a set of one or more steps accomplished by the participant(s), the set of steps comprising one or more steps selected from the group consisting of:
(i) writing down ideas to solve the one or more problem statements conceived in step 1(b)(iii) by the first group of participants;
(ii) reading the ideas to solve the one or more problem statements conceived in step 1(b)(iii) aloud as soon as the ideas are written down; and
(iii) handing the written ideas to a facilitator;
(b) displaying the written ideas via a display medium by the facilitator;
wherein, the first group of participants benefit from stimulus from the other participants of the first group of participants' ideas.

22. The method of claim 21 wherein the display medium comprises at least one of the following a wallboard, a flipchart, a poster board, a whiteboard, a chalkboard, a projection screen, a computer display, a Velcro™ board, a textile board and a felt board.

23. The method of claim 21 wherein the ideas are written on sticky pieces of paper.

24. The method of claim 20 wherein the silent brainstorming comprises:
(a) a set of one or more steps accomplished by the participant(s), the set of steps comprising one or more steps selected from the group consisting of:
(i) writing down ideas to solve the one or more problem statements conceived in step 1(b)(iii) by the first group of participants;
(ii) repeating step (i) for a period of time generating a plurality of the ideas to solve the one or more problem statements conceived in step 1(b)(iii);
(iii) handing the written ideas to a facilitator;
(b) displaying the written ideas via a display medium by the facilitator;
wherein, the first group of participants benefit from the quiet in the room to come up with new ideas to solve the one or more problem statements conceived in step 1(b)(iii) without distraction from other participants of the first group of participants.

25. The method of claim 24 wherein the display medium comprises at least one of the following a wallboard, a flipchart, a poster board, a whiteboard, a chalkboard, a projection screen, a computer display, a Velcro™ board, a textile board and a felt board.

26. The method of claim 24 wherein the ideas are written on sticky pieces of paper.

27. The method of claim 20 wherein the visually identifying relationships (VIR)/Forced Fit comprises:
(a) a set of one or more steps accomplished by a facilitator, comprising one or more steps selected from the group consisting of:
(i) supplying the first group of participants an object;
(ii) asking the first group participants to list attributes of the object; and
(iii) asking the first group of participants to use the attributes as stimuli to conceive problem statement(s) and/or element(s); and
(b) a set of one or more steps accomplished by the participant(s), the set of steps comprising one or more steps selected from the group consisting of:
(i) listing attributes of the object; and
(ii) conceiving problem statement(s) and/or element(s) using the attributes of the object as stimuli.

28. The method of claim 20 wherein the multi-voting comprises:
(a) pooling a list of ideas to solve the one or more problem statements conceived in 1(b)(iii);
(b) displaying the list of ideas via a display medium;
(c) determining idea selection criteria comprising discussions between a facilitator, an assignee's representative, and the first group of participants;
(d) distributing selection indicators from the facilitator to the first group of participants;
(e) selecting preferred solutions by the first group of participants using the selection indicators; and
(f) prioritizing the selections based on the first group of participants' selections using the selection indicators.

29. The method of claim 28 wherein the selection indicators comprise sticky dots.

30. The method of claim 29 wherein said sticky dots comprise one or more colors

31. The method of claim 28 wherein the display medium comprises at least one of the following a wallboard, a flipchart, a poster board, a whiteboard, a chalkboard, a projection screen, a computer display, a Velcro™ board, a textile board and a felt board.

32. The method of claim 20 wherein the categorizing/use multi-voting comprises a set of one or more steps accomplished by a facilitator, comprising one or more steps selected from the group consisting of:
(a) identifying suitable categories the categories comprising preferred elements of potential the inventions;
(b) collecting written possible ideas to solve the one or more problem statements conceived in 1(b)(iii), into groups corresponding to the categories; and
(c) using multi-voting to identify a preferred group.

33. The method of claim 32 wherein the multi-voting comprises:
(a) pooling a list of ideas to solve the problem statements;
(b) displaying the list of ideas via a display medium;
(c) determining idea selection criteria comprising discussions between a facilitator, an assignee's representative, and the first group of participants;
(d) distributing selection indicators from the facilitator to the first group of participants;
(e) selecting preferred solutions by the first group of participants using the selection indicators; and
(f) prioritizing the selections based on the first group of participants' selections using the selection indicators.

34. The method of claim 20 wherein the IOD™ comprises:
(a) placing a collection of “best” possible ideas to solve the one or more problem statements conceived in 1(b)(iii), by a facilitator; and
(b) a set of one or more steps accomplished by the participant(s), the set of steps comprising one or more steps selected from the group consisting of:
(i) finding a seed of the invention, the finding a seed comprising associating and combining at least one of the one or more problem statements conceived in 1(b)(iii) and at least one of the one or more elements conceived in 1(b)(iv);
(ii) finding a problem with the seed of the invention;
(iii) improving the invention by solving the problem with the seed of the invention; and
(iv) repeating steps (ii)-(iii) until a satisfactory basic invention has been identified.

35. The method of claim 20 wherein the adding more enablement comprises using one or more of the following:
(a) divergent creativity tools;
(b) convergent creativity tools; and
(c) existing experience of the first group of participants to add sufficient enablement.

36. The method of claim 1 wherein each of the inventions is shared with a second group of participants comprising displaying each of the inventions to the second group of participants and explaining each of the inventions.

37. The method of claim 1 wherein expanding each of the inventions comprises the first group of participants identifying ways to improve the inventions by identifying subordinate “how to” type problems through positive question(s).

38. The method of claim 37 wherein expanding each of the inventions comprises the second group of participants identifying ways to improve the inventions by identifying subordinate “how to” type problems through positive question(s).

39. The method of claim 37 wherein the positive question comprises a question(s) “How would you deal with a given problem “A’ in one of the inventions?” wherein the given problem “A’ comprises any possible problem related to the inventions.

40. The method of claim 1 wherein expanding each of the inventions comprises performing round-robin invention expansion the performing round-robin invention expansion comprises a set of one or more steps accomplished by the participant(s), the set of steps comprising one or more steps selected from the group consisting of:
(a) posting a description of each of the inventions;
(b) examining each of the inventions by the first group of one or more participants; and
(c) writing one or more of the following a subordinate “how to” problem statement, a solution to the subordinate “how to” problem and an alternate embodiment of the inventions on the description of each of the inventions by the first group of participants.

41. A method of facilitating the conception of one or more inventions in target market and/or technology areas by a group of one or more participants, the method comprising:
(a) a set of one or more steps accomplished by a facilitator, comprising one or more steps selected from the group consisting of:
(i) communicating basic concepts of patentable inventions to the first group of participants;
(ii) training the first group of participants on creativity and associative thinking methods;
(iii) defining the target market and/or technology areas in which inventions are desired; and
(iv) communicating guidelines for creative thinking to the participants; and
(b) a set of one or more steps accomplished by the participant(s), the set of steps comprising one or more steps selected from the group consisting of:
(i) conceiving of and establishing a mess statement;
(ii) conceiving of facts, data, and/or relevant attributes relevant to the mess statement;
(iii) conceiving of problem statements related to the mess statement, wherein the problem statements are identified using creative stimuli comprising one or more of the facts, data, and/or relevant attributes identified in step 1(b)(ii) as creative stimuli;
(iv) conceiving of elements of solutions to the problem statements, wherein the elements are conceived using creative stimuli comprising stimuli selected from the group consisting of:
(1) one or more of the problem statements conceived in step 1(b)(iii); and
(2) one or more of the facts, data, and attributes of step 1(b)(ii) as creative stimuli;
(v) conceiving of inventions using one or more creative stimuli comprising stimuli selected from the group consisting of:
(1) one or more of the creativity tools;
(2) one or more of the problem statements conceived in step 1(b)(iii); and
(3) one or more of the elements conceived in step 1(b)(ii);
(vi) sharing the inventions with other participants of the first group of participants; and
(vii) expanding each of the inventions to broaden and determine a path to full enablement;
(c) assessing the inventions based on pre-determined criteria to identify a list of most valuable inventions; and
(d) communicating to a decision making group information about the inventions, the information comprising a ranking of the invention according to one or more business or technical criteria.

42. A method of facilitating the conception of one or more inventions in target market and/or technology areas by a group of one or more participants, the method comprising:
(a) providing a first group of participants, wherein the participants have sufficient technical knowledge that each of the first group of participants is capable of contributing to finding solutions to the technical problem;
(b) providing a facilitator with expertise in creative problem solving and inventive problem solving;
(c) providing a display medium;
(d) providing note pads in sufficient quantity for a one-to-one correlation with the first group of participants;
(e) providing to the first group of participants a plurality of pictures for use as visually identifying relationships (VIR) tools;
(f) providing small objects for use as Forced Fit tools; and
(g) providing sticky dots for use in Multi-Voting.

44. The method of claim 42 wherein said first group of participants are provided colored pens with sufficient colors for a one-to-one correlation with the first group of participants so inventorship of each of plurality of derived inventions can be determined;
